(19) United States
(12) Patent Application Publication
(10) Pub. No.: US 2012/0320821 A1
(43) Pub. Date: Dec. 20, 2012

(54) METHOD AND DEVICE FOR RELAYING DATA

(76) Inventors: Sumei Sun, Singapore (SG); Chin Keong Ho, Singapore (SG); Peng Hui Tan, Singapore (SG)

(21) Appl. No.: 13/582,404

(22) PCT Filed: Mar. 2, 2011
(86) PCT No.: PCT/SG2011/000080

§ 371 Date: Aug. 31, 2012

(30) Foreign Application Priority Data
Mar. 2, 2010 (SG) 201001510-5

(51) Int. Cl. H04W 72/04

(52) U.S. Cl. 370/315

(57) ABSTRACT

A method of relaying data for a wireless frequency division multiple access network is disclosed herein. In a specific embodiment, the method comprises the steps of receiving data carried by respective subcarriers (320), network coding the data of at least two of the subcarriers having minimized correlation (350), and mapping the network coded data to a plurality of resource blocks for relaying to a destination (360). A device for relaying data for a wireless frequency division multiple access net-work is also disclosed.

### FIELD OF THE INVENTION

The invention relates to a method and device for relaying data for a wireless frequency division multiple access network.

### BACKGROUND OF THE INVENTION

In a technical specification for Long-Term Evolution (LTE)-Advanced (LTE-A) that is being developed under the 3rd Generation Partnership Project (3GPP), the technical specification aims for enhanced performance, e.g. the target peak data rate is 1 Gbps in the downlink and 500 Mbps in the uplink with the spectral efficiency of the downlink and uplink respectively targeted at 30 bps/Hz and 15 bps/Hz. The present LTE specification may not have such enhanced performance. Another aim is for cell-edge users to be supported with a much higher data rate than in the LTE specification in order to guarantee quality of experience (QoE).

In order to meet the aims of the LTE-A specification while supporting backward compatibility with earlier access schemes such as the Release 8 LTE, multicarrier modulation techniques in which the data symbols are orthogonal to each other in the frequency domain may be used, for example, orthogonal frequency division multiple access (OFDMA) and single carrier frequency division multiple access (SC-FDMA) based on discrete Fourier transform (DFT)-Spread OFDM will be used in LTE-A.

In OFDMA and SC-FDMA, different users are allocated to non-overlapping subcarrier sets based on their channel quality information (CQI) and their requested data rate. While this scheduling process may lead to multiuser diversity, very limited frequency diversity may be achieved for each user.

It is thus an object of the present invention to provide a method and device for relaying data which addresses at least one of the problems of the prior art and/or provide the public with a useful choice.

### SUMMARY OF THE INVENTION

In a specific expression of the invention, there is provided a method of relaying data for a wireless frequency division multiple access network comprising:
receiving data carried by respective subcarriers;
network coding the data of at least two of the subcarriers having minimized correlation; and
mapping the network coded data to a plurality of resource blocks for relaying to a destination.

Preferably, the network coding includes linear network coding. Advantageously, the at least two of the subcarriers has a lowest correlation amongst the subcarriers between their respective frequency domain channel coefficients.

Preferably, the at least two of the subcarriers is spaced integer multiples of N/L subcarrier indexes apart, where N is a number of subcarriers in the subcarriers, and L is a number of multipaths to the destination. Preferably, one of the plurality of resource blocks further comprises un-coded data.

The step of receiving the data may further comprise applying forward error correction to the data of the subcarriers, and interleaving the forward error correction coded data. Optionally, the method may comprise forward error correcting the data of the subcarriers, and interleaving the forward error corrected data. In these cases, the step of receiving the data may further comprise mapping the interleaved forward error correction coded data onto a plurality of modulation symbols.

Preferably, in one variation, the wireless frequency division multiple access network uses Orthogonal Frequency Division Multiple Access.

In a second variation, the wireless frequency division multiple access network uses Single Channel—Frequency Division Multiple Access. In such a case, the network coding may further comprise converting the data to the frequency domain by performing Fourier transform.

In both the first and second variations, preferably, the relaying to the destination is in the time domain. Optionally, the network coding is dependent on a relay technique selected from the group consisting of decode-and-forward relaying, amplify-and-forward relaying and demodulate-and-forward relaying. Advantageously, the network coding is optimized based on a criterion selected from the group consisting of minimum bit-error rate performance, maximum throughput and minimum energy for relaying to the destination.

Preferably, the network coding comprises applying to the data a unitary matrix. In a third variation, the network coding comprises applying to the data a Hadamard matrix. In a fourth variation, the network coding comprises applying to the data a rotated discrete Fourier transform matrix. In a fifth variation, the network coding comprises applying to the data a permutation matrix.

In all variations, the step of receiving data carried by respective subcarriers preferably includes receiving from at least two sources. In such a case, the at least two sources may be antennas of a device.

In a second specific expression of the invention, there is provided a decoding method for a wireless frequency division multiple access network comprising
receiving network coded data which is mapped to a plurality of resource blocks, the network coded data being formed from data which is network coded from at least two subcarriers having minimized correlations;
de-mapping the network coded data from the plurality of resource blocks; and
decoding the network coded data to recover the data.

Advantageously, the step of decoding the network coded data comprises applying a decoding matrix which removes a channel response and decodes the network coded data at the same time. In such a case, the step of applying the decoding matrix preferably comprises demodulating the network coded data to produce soft metric values, the soft metric values being a decoding of the network coded data, and de-interleaving the soft metric values.

In a variation of the decoding method, the network coded data comprises multiple data streams and the method further comprises jointly demodulating the multiple data streams. In such a case, one of the plurality of resource blocks preferably further comprises un-coded data and the de-mapping separates the network coded data from the un-coded data.

In a third specific expression of the invention, there is provided a communication method in a wireless frequency division multiple access network comprising
receiving at a relay data carried by respective subcarriers;
network coding the data of at least two of the subcarriers having minimized correlation;
mapping the network coded data to a plurality of resource blocks for relaying to a destination;
receiving the network coded data at the destination;
de-mapping the network coded data from the plurality of resource blocks; and
decoding the network coded data to recover the data.

In a fourth specific expression of the invention, there is provided a relay device for a wireless frequency division multiple access network comprising
a receiver configured to receive data carried by respective subcarriers; and
a processor configured to network code the data of at least two of the subcarriers having minimized correlation; and
wherein the processor is further configured to map the network coded data to a plurality of resource blocks for relaying to a destination.

In a fifth specific expression of the invention, there is provided an integrated circuit for a relay device of a wireless frequency division multiple access network comprising
an interface configured to receive data carried by respective subcarriers; and
a processing unit configured to network code the data of at least two of the subcarriers having minimized correlation; and
wherein the processing unit is further configured to map the network coded data to a plurality of resource blocks for relaying to a destination.

In a sixth specific expression of the invention, there is provided a relaying method for network coding in a wireless frequency division multiple access network comprising
receiving data carried by respective subcarriers;
linear network coding the data of at least two of the subcarriers; and
mapping the network coded data to a plurality of resource blocks for relaying to a destination.

It should be apparent that features relating to one specific expression may also be used or applied to another specific expression. For example, minimized correlation proposed in the first specific expression is also applicable for the sixth specific expression of the invention.

It can be appreciated from the described embodiment(s) that the method and device may:
support cell-edge users with a higher data rate than that in the LTE specification and may thus guarantee QoE;
exploit the frequency diversity in the relay node to destination node;
introduce frequency diversity gain and hence improve the power efficiency of the system, and
require no design modifications for user terminals as the coding scheme requires action only at the relay node and thus may ensure backward compatibility.

### BRIEF DESCRIPTION OF THE FIGURES

By way of example only, one or more embodiments will be described with reference to the accompanying drawings, in which:

FIG. 1 is a schematic drawing of a communications system having two source nodes, a relay node and a destination node, according to a preferred embodiment;

FIG. 2 is a schematic drawing of a structure of an OFDMA symbol for OFDMA transmissions performed in the communications system of FIG. 1;

FIG. 3 is a flow diagram of a method for network coding at the relay node of the communications system of FIG. 1;

FIG. 4 is a block diagram of an apparatus for network coding according to the method of FIG. 3 when OFDMA is used and where a plurality of coding groups contain data streams from two resource blocks;

FIG. 5 is a block diagram of a variation of the apparatus of FIG. 4 when OFDMA is used and where the plurality of coding groups contain data streams from a different number of resource blocks;

FIG. 6 is a block diagram of a variation of the apparatus of FIG. 4 when SC-FDMA is used and where the plurality of coding groups contain data streams from two resource blocks;

FIG. 7 is a flow diagram of a method for decoding at the destination node of FIG. 1 where the method of network coding of FIG. 3 is used;

FIG. 8 is a schematic drawing of the structure of an OFDMA symbol for OFDMA transmissions encoded at the relay node using the method of FIG. 3; and

FIG., 9 is a block diagram of an apparatus for decoding at the destination node according to the method of FIG. 7.

### DETAILED DESCRIPTION OF THE PREFERRED EMBODIMENT

FIG. 1 shows a communications system 100 according to the preferred embodiment. The communications system 100 comprises two source nodes—a first source node 120 and a second source node 122, a relay node 110 and a destination node 130. The communications system 100 thus comprises multiple source nodes or users capable of communicating with a common destination node or base station through one or more common relay nodes. During an uplink transmission, the two source nodes 120, 122 transmit information to the destination node 130 via a common relay node 110 using two hops. The first hop takes place during a first time slot where the source nodes 120,122 both transmit their data to the destination node 110.

Depending on the relay technique used, for example where a decode-and-forward relay technique is used, relay node 110 may decode the information it has received. Alternatively, other relay techniques such as a demodulate-and-forward or an amplify-and-forward scheme may be used. After receiving the information from the source nodes, relay node 110 then transmits the information on to destination node 130 in a second hop during a second time slot. The modulation technique used for the transmissions may for example be orthogonal frequency division multiple access (OFDMA) or single carrier—frequency division multiple access (SC-FDMA), or may be any other modulation technique known to a skilled person.

### Network Coding the Transmission

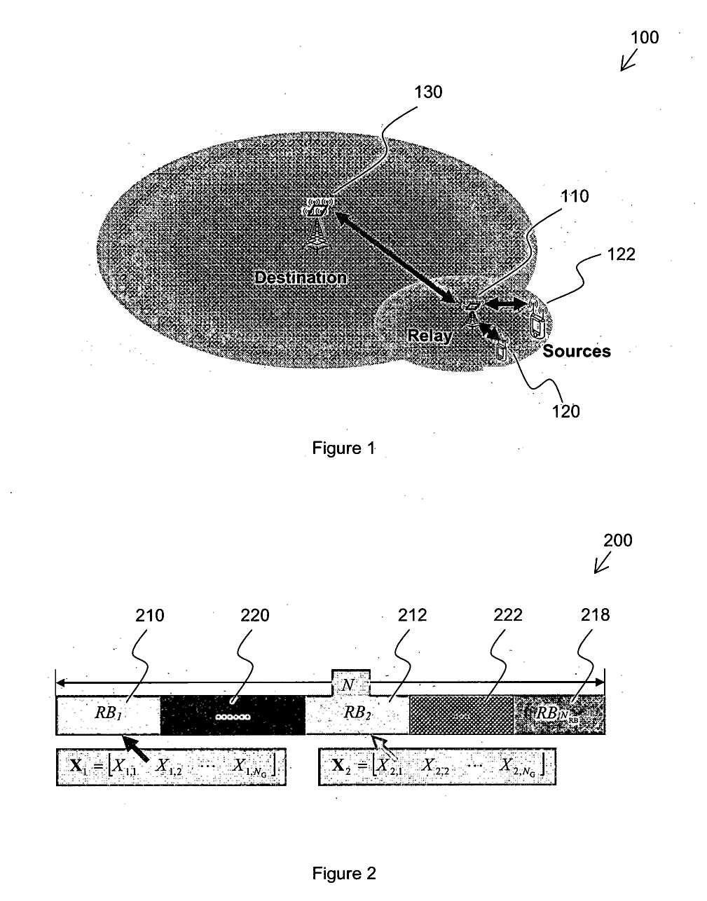

A method 300 for relaying the transmitted information will be described next with the aid of FIGS. 2, 3 and 4. The transmission is performed in the communications system 100 from source nodes 120, 122 to the destination node 130 via the relay node 110.

OFDMA transmission is used as an example. FIG. 2 shows the structure of an OFDMA symbol 200 for OFDMA transmissions performed in the method 300. Two resource blocks (RBs) i.e. RB₁ 210 and RB₂ 212 respectively are assigned to the two source nodes 120,122 for source-to-relay transmission. It is noted that while the resource blocks 210, 212 may be consecutively numbered, they do not have to occupy contiguous subcarrier blocks within the OFDMA symbol. The resource block RB_{N}_{_{RB}} 218 may be allocated to other source nodes. Two of the resource blocks 220,222 are subcarriers allocated to other resource blocks. Each OFDMA symbol 200 has N number of subcarriers which are grouped into N_{RB} localized resource blocks (RB) respectively denoted. RB₁, RB₂, . . . , RB_{N}_{_{RB}}. Each RB has N_{G} number of subcarriers such that N_{RB}×N_{G}=N.

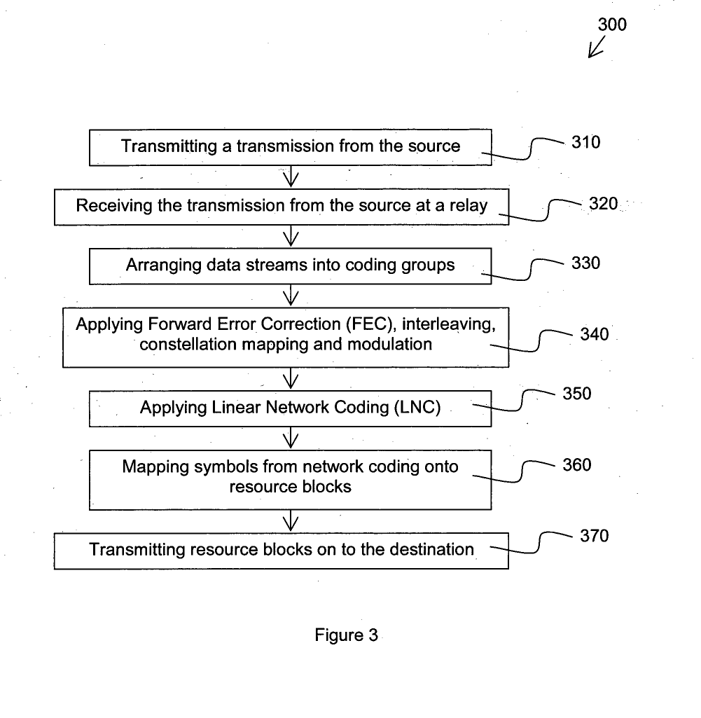

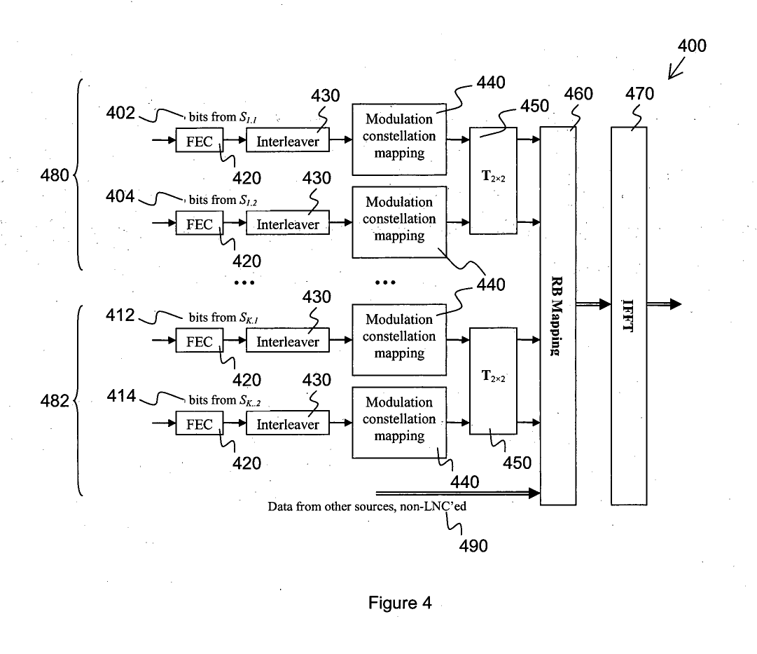

Turning now to FIGS. 3 and 4, the method 300 and an apparatus 400 for the method 300 will be described. FIG. 3 shows the method 300 for network coding at the relay node 110 the transmitted information from the source nodes 120, 122 to a destination node 130. FIG. 4 is a block diagram showing an apparatus for linear network coding at the relay node 110 when OFDMA is used and where the coding groups each contain data streams from two resource blocks.

In Step 310, the transmission is transmitted from the two source nodes 120, 122. This occurs during the first time slot when the first source node 120 transmits the data symbols X₁=[X_{1,1},X_{1,2}, . . . , X_{1,N}_{_{G}}] and the second source node 122 transmits X₂=[X_{2,1}, X_{2,2}, . . . , X_{2,N}_{_{G}}].

In Step 320, the relay node 110 receives and processes the transmission from the first and the second source nodes 120,122. In this step, an estimate of the symbols in the transmission is obtained by demodulation, or by demodulation and decoding. Each resource block in the transmission results in a decoded data stream after symbol estimation. The symbol estimation technique used depends on the relaying scheme deployed in the method 300. In this example, the decode-and-forward scheme is used and perfect decoding is assumed at the relay node 110.

In Step 330, the data streams received from the source nodes are arranged into coding groups. Optionally, this arrangement may be done using any combination of the strategies of:
having coding groups of higher dimensions;
partitioning the data streams into multiple coding groups; and
optimizing the grouping of data streams into coding groups.

These strategies will be described to a greater detail later in this description.

In the present example, the data streams from the resource blocks of the first and the second source nodes 120,122 are grouped into a single coding group which comprises N_{G}=2 subcarrier pairs. The n^{th} pair of this subcarrier group comprises the n^{th} decoded data symbol from the two data streams, i.e.

$${X}_{p} = [ \begin{matrix}{X}_{1 , p} \\ {X}_{2 , p}\end{matrix} ] , p = 1 , 2 , … , {N}_{G} \qquad ( 1 )$$

In Step 340, the coding groups are subjected to Forward Error Correction (FEC), interleaving and then constellation mapping and modulation. In the apparatus 400, the coding groups 480, 482 each contain data streams from two resource blocks (i.e. the data streams 402 and 404 for the coding group 480, and the data streams 412 and 414 for the coding group 482). The data streams 402, 404, 412 and 414 from corresponding resource blocks are bit streams originating from different source nodes. These data streams 402, 404, 412 and 414 are denoted using the expression S_{A, B} i.e. they are respectively denoted by S_{1,1}, S_{1,2}, S_{K,1} and S_{K,2}. In the expression S_{A, B} denoting a data stream, the subscript A is an index number of the coding group of the data stream. The subscript B is an index number of the source node from which the data stream is received. FEC is first performed on each of the data streams by the FEC units 420. The corrected data stream is then subjected to bit-interleaving by an interleaver 430 and then constellation mapping and modulation by a modulation unit 440.

In Step 350, linear network coding (LNC) is applied. The LNC matrix is applied for each coding group by a coding unit 450. Taking the coding group 480 as an example, a LNC matrix is applied pair-wise individually to each subcarrier pair of a coding group 480 as follows

$$\{ \begin{matrix}{X}_{LNC , 1} = [ \begin{matrix}{X}_{LNC , 1 , 1} \\ {X}_{LNC , 2 , 1}\end{matrix} ] = T [ \begin{matrix}{X}_{1 , 1} \\ {X}_{2 , 1}\end{matrix} ] \\ {X}_{LNC , 2} = [ \begin{matrix}{X}_{LNC , 1 , 2} \\ {X}_{LNC , 2 , 2}\end{matrix} ] = T [ \begin{matrix}{X}_{1 , 2} \\ {X}_{2 , 2}\end{matrix} ] \\ ⋮ \\ {X}_{LNC , {N}_{G}} = [ \begin{matrix}{X}_{LNC , 1 , {N}_{G}} \\ {X}_{LNC , 2 , {N}_{G}}\end{matrix} ] = T [ \begin{matrix}{X}_{1 , {N}_{G}} \\ {X}_{2 , {N}_{G}}\end{matrix} ]\end{matrix} \qquad ( 2 )$$

T denotes the 2×2 unitary LNC matrix, where T^{H}T=TT^{H}=I₂. X_{LNC,1,1} and X_{LNC,2,1} to X_{LNC,1,N}_{_{G}} and X_{LNC,2,N}_{_{G}} respectively denote X_{1,1} and X_{2,1} to X_{1,N}_{_{G}} and X_{2,N}_{_{G}} after the application of LNC. It is noted that the data streams assigned to the two resource blocks RB₁, RB₂ would have been allocated according to the strategies mentioned above in Step 330. Also, by precoding data streams from at least two resource blocks in the frequency domain, additional frequency diversity gain may be introduced and hence may improve the power efficiency of the communications system 100.

In general, given S data symbols, the LNC outputs S LNC coded symbols such that

X_{LNC,n}=TXₙ, n=1, . . . , N_{G}. (3)

The LNC coding matrix of size S by S, is given by

$$T = [ \begin{matrix}{t}_{11} & {t}_{12} & … & {t}_{1 S} \\ {t}_{21} & {t}_{22} & … & {t}_{2 S} \\ ⋮ & ⋮ & ⋱ & ⋮ \\ {t}_{S 1} & {t}_{S 1} & … & {t}_{SS}\end{matrix} ] , \qquad ( 4 )$$

and T^{H}T=TT^{H}=I_{S}, with I_{S} being a S×S identity matrix.

The coding matrix T optionally may be a Hadamard matrix. The Hadamard matrix may be constructed using any method that is known in the art. If S=2^{K} for some positive integer K, then T may be obtained as T=H_{S}, where H_{S} is constructed using Sylvester Construction. In this case, H₂_{^{k}}=H₂\textcircled{x}H₂_{^{k-1}} for a positive integer k, where \textcircled{x} denotes the Kronecker product and H₁=[1], i.e., a matrix of size 1 with the single element being 1. Alternatively, Paley construction may also be used to form a Hadamard matrix.

Optionally, the coding matrix T may also be a Rotated Discrete Fourier Transform (DFT) matrix. In this case, T=FD where D is a diagonal matrix with the n th diagonal element given by e^{-j(n-1)π(2S)} for n=1, . . . , S, and F is the DFT matrix with the (m,n) th element given by e^{-jnπ/(2S)} for m=1, . . . , S, and n=1, . . . , S.

Optionally, the coding matrix T may also be a Permutation matrix such that

$$T = [ \begin{matrix}{e}_{p ( 1 )} \\ ⋮ \\ {e}_{p ( S )}\end{matrix} ]$$

is a permutation matrix, where p(.) uniquely maps an index in the set {1, . . . , S} to an index in the set {1, . . . , S}. eₙ is a row vector of length S with 1 in the n th column position and 0 in every other position.

An optimal coding matrix T implementing LNC may be selected depending on the relay processing performed prior to LNC, for example the processing for the different relay schemes such as a demodulate-and-forward scheme, decode-and-forward scheme, or amplify-and-forward scheme. The optimal coding matrix may also be selected based on an optimization criterion, for example to achieve a minimized bit-error rate performance, or a maximized throughput, or to minimize the energy used for relaying onto the destination node.

In Step 360, the symbols resulting from network coding are mapped onto subcarriers in resource blocks for transmission onto the destination node. The network coded symbols are mapped onto subcarriers in the apparatus 400 by the RB mapping unit 460. It is noted that the resource blocks used by the relay node 110 for onward transmission to the destination node may not necessarily be the same resource blocks upon which the relay node 110 receives data.

If a coding group contains data to be mapped to two resource blocks, the output symbols from LNC for each coding group is re-organized respectively into two streams, each of which contains N_{G} symbols. The first stream consists of the first symbol of each output vector from LNC, i.e., X_{LNC,1,1}, X_{LNC,1,2}, . . . X_{LNC,1,N}_{_{G}} and the second consists of the second symbol of each output vector from LNC, i.e., X_{LNC,2,1}, X_{LNC,2,2}, . . . , X_{LNC,2,N}_{_{G}}.

Thus, in the present embodiment where two resource blocks for relay node to destination node transmission are assigned to the two data streams, the output after applying LNC can be denoted

$$\{ \begin{matrix}{X}_{LNC , {RB}_{1}} = [ \begin{matrix}{X}_{LNC , 1 , 1} & {X}_{LNC , 1 , 2} & … & {X}_{LNC , 1 , {N}_{G}}\end{matrix} ] \\ {X}_{LNC , {RB}_{2}} = [ \begin{matrix}{X}_{LNC , 2 , 1} & {X}_{LNC , 2 , 2} & … & {X}_{LNC , 2 , {N}_{G}}\end{matrix} ]\end{matrix} \qquad ( 5 )$$

where X_{LNC,RB}_{₁} and X_{LNC,RB}_{₂} will be mapped respectively to two resource blocks RB₁ and RB₂.

In alternative embodiments where the LNC is implemented on data streams received from more than two resource blocks, then the re-grouping of the LNC output symbols may use a similar procedure where the output symbols are mapped onto the same number of resource blocks as that of the resource blocks upon which the data streams arrived at the relay node. In other words, if LNC were to be applied to a coding group comprising 3 data streams from 3 resource blocks, the output symbols from LNC may be mapped onto 3 resource blocks for onward transmission. Further, data from other sources 490 which are not subjected to LNC may also be mapped onto resource blocks for onward transmission.

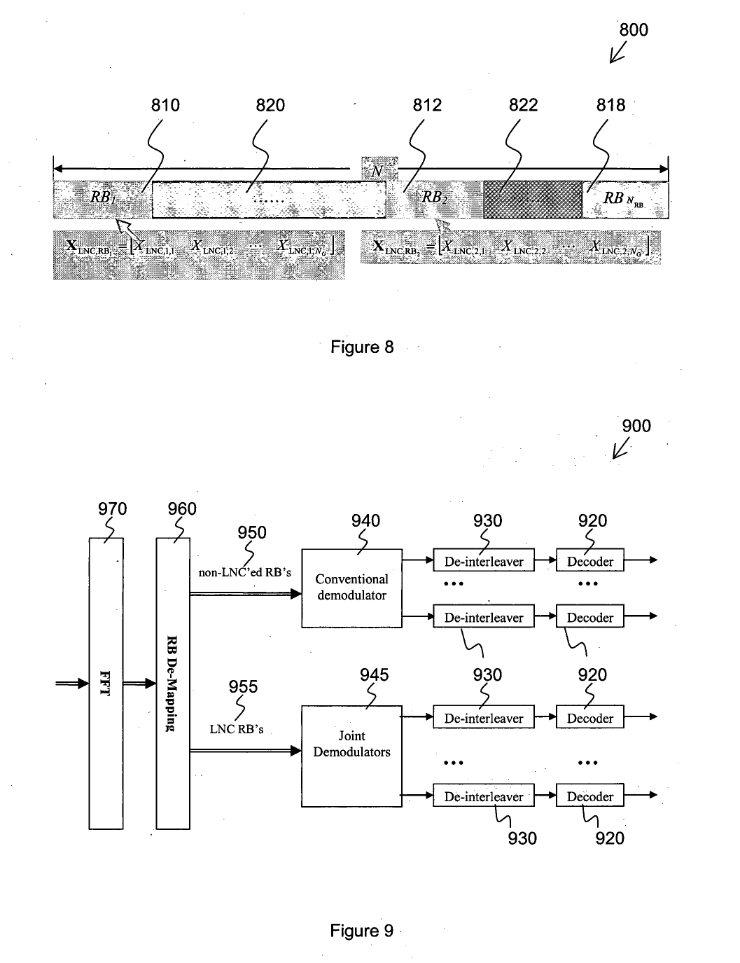

FIG. 8 shows the structure of an OFDMA symbol 800 for OFDMA transmissions from the relay node 110 encoded at the relay node using the method 300 of FIG. 3. The resource blocks RB₁ 810 and RB₂ 812 respectively may contain the coded symbols X_{LNC,RB}_{₁} and X_{LNC,RB}_{₂}. The resource block RB_{N}_{_{RB}} 818 may contain coded symbols from other coding groups. The blocks 820, 822 are subcarriers allocated to other resource blocks and may for example contain data symbols which are not coded in Step 350. Similar to the OFDMA symbol 200, the OFDMA symbol 800 has N number of subcarriers and while the resource blocks RB₁ and RB₂ 810,812 may be consecutively numbered, they do not have to occupy contiguous subcarrier blocks within the OFDMA symbol.

In Step 370, the OFDMA symbol 800 comprising the resource blocks RB₁ and RB₂ 810, 812 is transmitted to the destination node 130. An Inverse Fast Fourier Transform (IFFT) is performed by an IFFT unit 470 to convert the frequency components of the OFDMA symbol 800 into the time domain.

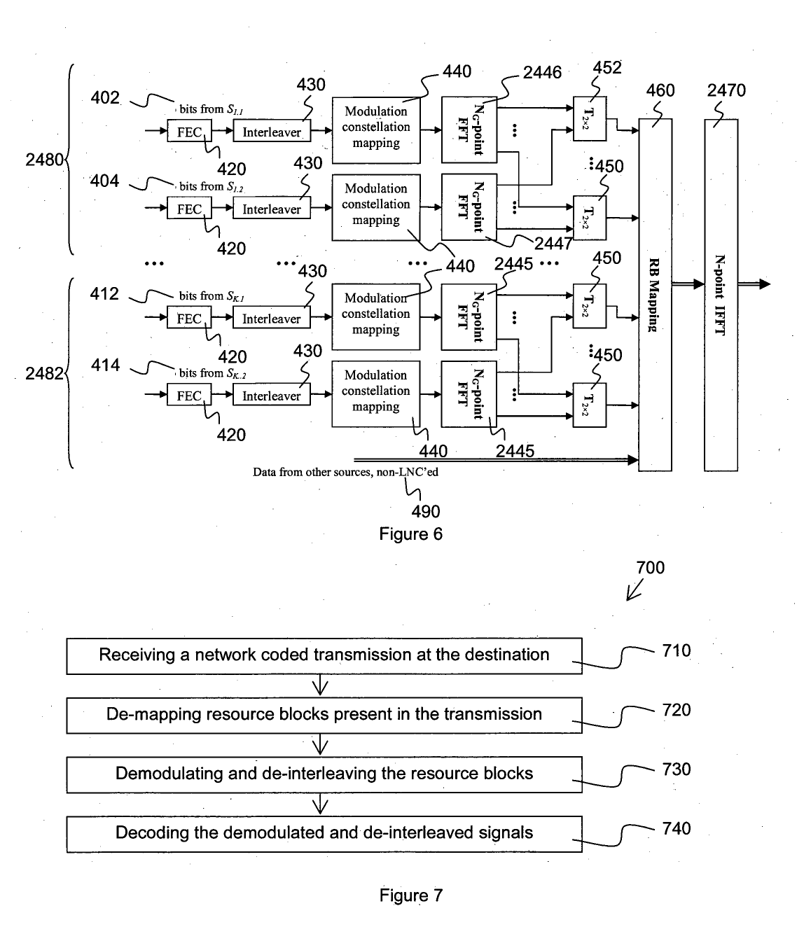

Alternative embodiments of the apparatus 400 will be described next. Referring now to FIG. 6, FIG. 6 shows a block diagram of a variation of the apparatus of FIG. 4 when SC-FDMA is used and where the coding groups 480, 482 contains data streams from two resource blocks. Like components/processes in FIG. 6 use the same references as those employed in FIG. 4. Two coding groups 2480, 2482 are present and each coding group contains data streams from two resource blocks i.e. the data streams 402 and 404 for the coding group 2480 and the data streams 412 and 414 for the coding group 2482. In Step 340, a N_{G}-point Fast Fourier Transform (FFT) is performed by a N_{G}-point FFT unit 2445, 2446 or 2447 to convert the signal resulting from constellation mapping and modulation i.e. the signal resulting from the modulation unit 440 to the frequency domain. The output from each FFT unit 2445, 2446 or 2447 has N_{G} symbols and is then arranged for LNC by a coding unit 450 or 452.

Taking the coding group 2480 as an example, N_{G}=2. The output of the first and second FFT units 2446 and 2447 of the coding group, 2480 are each N_{G}=2 symbols long. The output from the first FFT unit 2446 forms the first row of a 2×N_{G} matrix. The output from the second FFT unit 2447 forms the second row of the 2×N_{G} matrix. LNC is then applied on the 2×N_{G} matrix by the coding unit 452.

Further, in Step 370, an N-point IFFT unit 2470 is used instead of the IFFT unit 470. The N-point IFFT unit 2470 performs a fixed length IFFT to convert the frequency components of the OFDMA symbol 800 into the time domain.

Next, the strategies for arranging data streams into coding groups in Step 330 will be described. It is noted that these strategies may be useful when there are data streams from more than two resource blocks that have to be network coded.

### Step 330: Having Coding Groups of Higher Dimensions

Instead of having N_{G} number of coding groups of subcarrier pairs (i.e. with a dimension of 2), N_{G} coding groups containing sets of subcarriers may be formed. In this case, the coding groups may each have a subcarrier set with S data symbols (i.e. the dimension is S). Each n th coding group thus comprises the n th decoded data symbol from each of the S data streams, i.e.,

$${X}_{n} = [ \begin{matrix}{X}_{1 , n} \\ {X}_{2 , n} \\ ⋮ \\ {X}_{S , n}\end{matrix} ] , n = 1 , 2 , … , {N}_{G} \qquad ( 6 )$$

A S×S unitary LNC coding matrix is then applied to the subcarrier set of each coding group individually in Step 350. In Step 360, The LNC output is then re-grouped into S coded data streams, each coded data stream having N_{G} LNC-encoded symbols and mapped to S resource blocks.

Step 330: Partitioning the Data Streams into Multiple Coding Groups

In cases where there are more than two resource blocks to be network coded, the resource blocks may be partitioned into multiple coding groups, with each group containing two or more resource blocks. In other words, the number of resource blocks assigned to each coding group may be different—some coding groups have be assigned a pair of resource blocks, other coding groups may have higher dimensions. LNC is then applied to each coding group separately. This partitioning may be done with the view of optimizing the grouping of the resource blocks into coding groups as will be described later.

Referring to FIG. 4, the embodiment of FIG. 4 partitions the data streams into K coding groups i.e. coding group 480 to coding group 482. Each coding group contains data streams from two resource blocks.

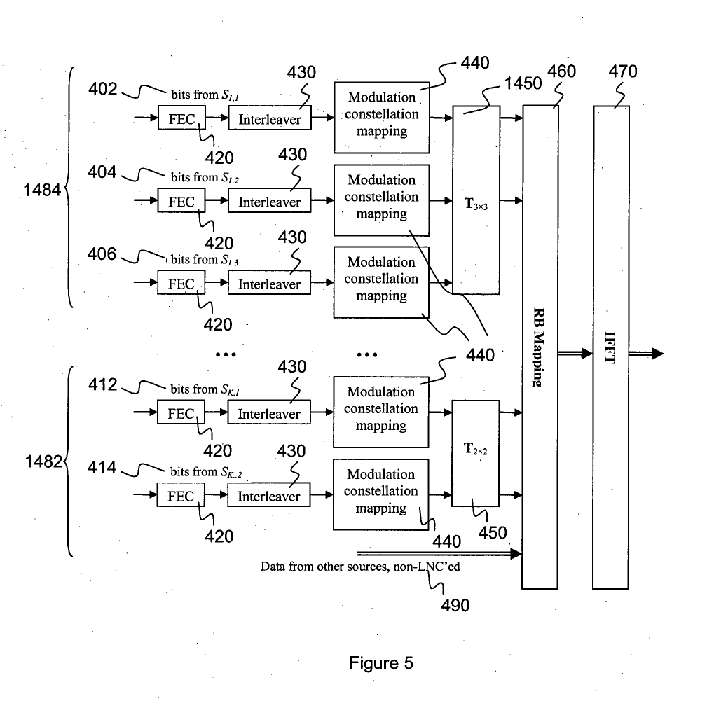

Referring next to FIG. 5, FIG. 5 is a block diagram showing a variation of the linear network coding at the relay node 110 when OFDMA is used and like components/processes use the same references as that used in FIG. 4. The coding groups 1484, 1482 contain data streams from a different number of resource blocks. The data streams are partitioned into K=2 coding groups. Some coding groups may contain data streams from two resource blocks e.g. coding group 1482 which has the data streams 412 and 414, while some may contain data streams from more than two resource blocks e.g. coding group 1484 which has data streams 402, 404 and 406 from 3 resource blocks. Because the coding group 1484 has 3 data streams, in Step 350 where LNC is applied, the coding unit 1450 applies a 3-by-3 coding matrix.

Referring now to FIG. 6, the embodiment of FIG. 6 uses SC-FDMA and partitions the data streams into K=2 coding groups i.e. coding group 2480 and coding group 2482. Each coding group contains data streams from two resource blocks. As is done when OFDMA modulation is used, the application of LNC 350 is performed in the frequency domain.

It is notable that the strategy of partitioning the data streams into multiple coding groups may be used in conjunction with any of the other strategies disclosed in this specification.

Step 330: Optimizing the Grouping of Data Streams into Coding Groups

Optimizing the grouping of data streams into coding group may compensate for frequency diversity loss due to the localized subcarrier assignment in the OFDMA resource allocation. An ideal arrangement may be to have two or more resource blocks that are as uncorrelated as possible in one coding group.

Assuming that the relay node to destination node channel has L independent and identically distributed complex Gaussian multipaths with zero mean and variance 1/L, i.e., the relay node to destination node channel has a wide-sense stationary uncorrelated scattering (WSSUS) uniform power delay profile, the frequency domain channel coefficient for subcarrier k is

$${H}_{k} = {\sum }_{l = 0}^{L - 1} {h}_{l} {e}^{- j \frac{2 π lk}{N}} , k = 0 , 1 , … , N - 1 \qquad ( 7 )$$

N is the total number of subcarriers present in the transmission symbol. The subcarrier correlation may then be written as

$$\begin{matrix}E \{ {H}_{k} {H}_{k}^{*} \} = E \{ {\sum }_{l = 0}^{L - 1} {h}_{l} {e}^{- j \frac{2 π lk}{N}} {\sum }_{p = 0}^{L - 1} {h}_{p}^{*} {e}^{j \frac{2 π pm}{N}} \} \\ = {\sum }_{l = 0}^{L - 1} {\sum }_{p = 0}^{L - 1} E \{ {h}_{l} {h}_{P}^{*} \} {e}^{j \frac{ 2 π pm}{N}} {e}^{- j \frac{2 π lk}{N}} \\ = \frac{1}{L} {\sum }_{l = 0}^{L - 1} {e}^{j \frac{2 π l ( m - k )}{N}} \\ = \frac{1 - {e}^{j \frac{2 π L ( m - k )}{N}}}{1 - {e}^{j \frac{2 π ( m - k )}{N}}}\end{matrix} \qquad ( 8 )$$

If two subcarriers m and k are spaced N/L subcarrier indexes or integer multiples of N/L subcarrier indexes apart, their channel coefficients (which are also Gaussian distributed) may be uncorrelated, hence independent.

Assuming an exponential power delay profile for the relay node to destination node channel with L independent complex Gaussian multipaths with zero mean and variance e^{αl}/β, l=0, . . . , L−1, where

$$β = \frac{1 - {e}^{- α L}}{1 - {e}^{- α}} , \qquad ( 9 )$$

the frequency domain correlation between channel coefficients for the subcarrier k and m may be written as

$$\begin{matrix}\begin{matrix}E \{ {H}_{k} {H}_{m}^{*} \} = E \{ {\sum }_{l = 0}^{L - 1} {h}_{l} {e}^{- j \frac{2 π lk}{N}} {\sum }_{p = 0}^{L - 1} {h}_{p}^{*} {e}^{j \frac{2 π pm}{N}} \} \\ = {\sum }_{l = 0}^{L - 1} {\sum }_{p = 0}^{L - 1} E \{ {h}_{l} {h}_{p}^{*} \} {e}^{j \frac{ 2 π pm}{N}} {e}^{- j \frac{2 π lk}{N}} \\ = \frac{1}{β} {\sum }_{l = 0}^{L - 1} {e}^{j \frac{ 2 π l ( m - k )}{N} - α l} \\ = \frac{1 - {e}^{j \frac{ 2 π L ( m - k )}{N} - α L}}{β ( 1 - {e}^{j \frac{2 π ( m - k )}{N} - α} )}\end{matrix} & ( 10 ) \\ Hence , & \\ \vert E \{ {H}_{k} {H}_{m}^{*} \} \vert = \frac{1}{β} \sqrt{\frac{1 + {e}^{- 2 α L} - 2 {e}^{- α L} cos ( \frac{2 π L}{N} ( m - k ) )}{1 + {e}^{- 2 α} - 2 {e}^{- α} cos ( \frac{2 π}{N} ( m - k ) )}} & ( 11 )\end{matrix}$$

When the two subcarriers m and k are spaced N/L subcarrier indexes or integer multiples of N/L subcarrier indexes apart, the correlation between their channel coefficients may be lower than other subcarrier spacing values. Thus, resource blocks allocated to each coding group may be spaced N/L subcarrier indexes or integer multiples of N/L subcarrier indexes apart to minimize correlation between subcarriers.

It is envisaged that while the minimization of correlation is performed in this example for two subcarriers m and k, in the case where the strategy of having higher dimensional coding groups is used in conjunction with the present strategy, the minimization of correlation may not be done pair-wise, but rather may be done with the aim of minimizing the correlation amongst all the subcarriers of the higher dimensional coding group.

Further, where the strategy of partitioning into multiple coding groups is also used, the minimization of correlation may not be locally optimum within each coding group, but the aim of minimizing the correlation amongst subcarriers may be a globally optimum allocation of subcarriers across the multiple coding groups.

### Decoding the Transmission

At the destination node 130, the network coded transmission is received and decoded. FIG. 7 shows a method 700 for decoding the network coded transmission at the destination node 130. FIG. 9 is a block diagram of an apparatus 900 for decoding at the destination node according to the method of FIG. 7. The method 700 will be described next with the aid of FIGS. 7 and 9.

In Step 710, the network coded transmission is received at the destination node 130. The received signal is converted into frequency domain in the apparatus 900 by performing Fast Fourier Transform (FFT) in a FFT unit 970.

In Step 720, the resource blocks present in the network coded transmission are de-mapped by a demapper 960. When doing so, the resource blocks may be separated into two categories i.e. LNC resource blocks 955 which have LNC applied, and non-LNC resource blocks 950 which do not have LNC applied. Other forms of coding however may be applied to the non-LNC resource blocks 950.

In Step 730, demodulation and de-interleaving are performed on the LNC resource blocks 955 and non-LNC resource blocks 950. Demodulation is performed to calculate the soft metric values for the decoders 920 which perform FEC decoding. For the signals from the LNC resource blocks 955, joint detection may be implemented for each subcarrier pair or collection of subcarriers as grouped in the coding groups of the relay node 110. Any joint detection scheme known to the skilled person may be applied, e.g. the maximum likelihood detection. This is done in the apparatus 900 by a joint demodulator 945 and the joint demodulator 945 thus decodes the LNC coding that is present in the data of the LNC resource blocks 955.

For the signals originating from LNC resource blocks 955, taking for example the case where the coding groups comprise two RBs, (e.g. the embodiment of FIG. 4 or 6), the signals Y_{LNC,k}_{₁} and Y_{LNC,k}_{₂} may be written as

$$\begin{matrix}[ \begin{matrix}{Y}_{LNC , {k}_{1}} \\ {Y}_{LNC , {k}_{2}}\end{matrix} ] = [ \begin{matrix}{H}_{{k}_{1}} & 0 \\ 0 & {H}_{{k}_{2}}\end{matrix} ] T [ \begin{matrix}{X}_{{k}_{1}} \\ {X}_{{k}_{2}}\end{matrix} ] + [ \begin{matrix}{V}_{{k}_{1}} \\ {V}_{{k}_{2}}\end{matrix} ] \\ = {H}_{T} [ \begin{matrix}{X}_{{k}_{1}} \\ {X}_{{k}_{2 }}\end{matrix} ] + [ \begin{matrix}{V}_{{k}_{1}} \\ {V}_{{k}_{2}}\end{matrix} ]\end{matrix} \qquad ( 12 )$$

where subscript index k₁ and k₂ denote two LNC resource blocks. Similar equations may be derived for coding groups of higher dimensions.

T denotes the coding matrix that was applied for LNC in Step 350 of the relay node 110. Hₖ_{₁} and Hₖ_{₂} respectively denote the channel response on the subcarriers of the k₁ and k₂ LNC resource blocks. The signals originating from LNC resource blocks 955 may thus be decoded in block unit 945 by applying the decoding matrix H_{T}. This generates the soft metric values which are de-interleaved by the de-interleavers 930. The de-interleaved soft metric values are then subsequently used by the decoders 920.

For signals from the non-LNC resource blocks 950, conventional demodulation may be implemented using any technique that is known to the skilled person. This is done in the apparatus 900 by a conventional demodulator 940. The signals originating from the non-LNC resource blocks 950 contain un-coded data i.e. data which is not network coded and may be written as

Y_{non-LNC,k}=HₖXₖ+Vₖ (13)

where Hₖ, Xₖ, and Vₖ denote respectively the frequency domain channel response on a subcarrier k, the non-LNC user data and the Additive White Gaussian Noise (AWGN). The signals originating from the non-LNC resource blocks 950 may thus be demodulated with any conventional schemes in blocks 940. Soft metric values are generated by the conventional demodulator 940 and these are de-interleaved by the de-interleavers 930. The de-interleaved soft metric values are then used by the decoders 920.

In Step 740, the signals after the demodulation and de-interleaving are decoded in decoders 920. The decoders 920 perform FEC decoding and may be implemented using any technique that is known to the skilled person.

While the communications system 100 of FIG. 1 is illustrated with two source nodes i.e. the first and the second source nodes 120, 122, alternative embodiments may have more than two source nodes. The method 300 for network coding a transmission and the method 700 for decoding the network coded transmission are not limited to a communications system with only two source nodes. When more than two source nodes are associated with the relay node, the LNC scheme can be applied to all the data streams from the source nodes in a single coding group. Optionally, the source nodes may be partitioned into a number of disjoint coding groups, and LNC is applied separately to each coding group.

Alternative embodiments may also use other relaying approaches known to the skilled person, e.g., amplify-and-forward approach or demodulate-and-forward.

Alternative embodiments may also use other forms of modulation schemes other than OFDMA or SC-FDMA by applying LNC to data streams in the frequency domain.

Alternative embodiments may also use the method 300 for network coding a transmission and/or the method 700 for decoding the network coded transmission with communication devices with multiple antennas. In such a case, as an example, there may be no need for having multiple source nodes. Rather, each antenna may be regarded as a source node. Data streams transmitted on each antenna of a single source node will be received as data streams from multiple source nodes at the relay node 110 and resource block grouping and linear network coding may be applied.

The described embodiments should not be construed as limitative. For example, while the described embodiments describe the network coding of a transmission and decoding of a network coded transmission as methods 300 and 700, it would be apparent that the methods may be implemented as a device, specifically as a mobile device or an Integrated Circuit (IC). The mobile device or IC may include a processing unit configured to perform the various method steps discussed earlier.

Also, while the method 300 and method 700 are described using linear network coding, however it is envisaged that the network coding applied does not have to be linear and other suitable network coding methods may be used. As an example, the network coding applied may take the form of a bit-wise XOR operation.

Further, while the communications system 100 is described as a two-hop communications system where the transmission from the source nodes to the relay node takes place during a first time slot and the transmission from the relay node to the destination node takes place during a second time slot, it should be apparent that the example embodiment may be used in a multiple-hop communications system. In this case, there may be multiple intermediate relay nodes between the source nodes and the destination node, and the relay nodes may relay data originating from the source nodes between themselves before finally transmitting to the destination node.

Further, while the method 300 and method 700 are described as two methods, it should be understood that the methods may be used one after another for receiving, then relaying within a single device. In such a case, the single device may for example perform the method 700 for decoding the network coded transmission to produce data streams upon which the method 300 for network coding a transmission is then performed.

Whilst example embodiments of the invention have been described in detail, many variations are possible within the scope of the invention as will be clear to a skilled reader.

1. A method of relaying data for a wireless frequency division multiple access network comprising
receiving data carried by respective subcarriers;
network coding the data of at least two of the subcarriers having minimized correlation; and
mapping the network coded data to a plurality of resource blocks for relaying to a destination.

2. A method according to claim 1 wherein the network coding includes linear network coding.

3. A method according to claim 1 wherein the at least two of the subcarriers has a lowest correlation amongst the subcarriers between their respective frequency domain channel coefficients.

4. A method according to claim 3 wherein the at least two of the subcarriers is spaced integer multiples of N/L subcarrier indexes apart;
where
N is a number of subcarriers in the subcarriers; and
L is a number of multipaths to the destination.

5. A method according to claim 1 wherein one of the plurality of resource blocks further comprises un-coded data.

6. A method according to claim 1 wherein receiving the data further comprises
applying forward error correction to the data of the subcarriers; and
interleaving the forward error correction coded data.

7. A method according to claim 6 wherein receiving the data further comprises
mapping the interleaved forward error correction coded data onto a plurality of modulation symbols.

8. A method according to claim 1 wherein the wireless frequency division multiple access network uses Orthogonal Frequency Division Multiple Access.

9. A method according to claim 1 wherein the wireless frequency division multiple access network uses Single Channel—Frequency Division Multiple Access.

10. A method according to claim 9 wherein the network coding further comprises
converting the data to the frequency domain by performing Fourier transform.

11. A method according to claim 1 wherein the relaying to the destination is in the time domain.

12. A method according to claim 1 wherein the network coding is dependent on a relay technique selected from the group consisting of:
decode-and-forward relaying;
amplify-and-forward relaying; and
demodulate-and-forward relaying.

13. A method according to claim 1 wherein the network coding is optimized based on a criterion selected from the group consisting of:
minimum bit-error rate performance;
maximum throughput; and
minimum energy for relaying to the destination.

14. A method according to claim 1 wherein the network coding comprises applying to the data a unitary matrix.

15. A method according to claim 1 wherein the network coding comprises applying to the data a Hadamard matrix.

16. A method according to claim 1 wherein network coding comprises applying to the data a rotated discrete Fourier transform matrix.

17. A method according to claim 1 wherein the network coding comprises applying to the data a permutation matrix.

18. A method according to claim 1 wherein receiving data carried by respective subcarriers includes receiving from at least two sources.

19. A method according to claim 18 wherein the at least two sources are antennas of a device.

20. A decoding method for a wireless frequency division multiple access network comprising
receiving network coded data which is mapped to a plurality of resource blocks, the network coded data being formed from data which is network coded from at least two subcarriers having minimized correlations;
de-mapping the network coded data from the plurality of resource blocks; and
decoding the network coded data to recover the data.

21. A decoding method according to claim 20 wherein decoding the network coded data comprises
applying a decoding matrix which removes a channel response and decodes the network coded data at the same time.

22. A decoding method according to claim 21 wherein applying the decoding matrix comprises
demodulating the network coded data to produce soft metric values, the soft metric values being a decoding of the network coded data; and
de-interleaving the soft metric values.

23. A decoding method according to claim 20 wherein the network coded data comprises multiple data streams and the method further comprises
jointly demodulating the multiple data streams.

24. A decoding method coding according to claim 23 wherein one of the plurality of resource blocks further comprises un-coded data and the de-mapping separates the network coded data from the un-coded data.

25. A communication method in a wireless frequency division multiple access network comprising
receiving at a relay data carried by respective subcarriers;
network coding the data of at least two of the subcarriers having minimized correlation;
mapping the network coded data to a plurality of resource blocks for relaying to a destination;
receiving the network coded data at the destination;
de-mapping the network coded data from the plurality of resource blocks; and
decoding the network coded data to recover the data.

26. A relay device for a wireless frequency division multiple access network comprising
a receiver configured to receive data carried by respective subcarriers; and
a processor configured to network code the data of at least two of the subcarriers having minimized correlation; and
wherein the processor is further configured to map the network coded data to a plurality of resource blocks for relaying to a destination.

27. An integrated circuit for a relay device of a wireless frequency division multiple access network comprising
an interface configured to receive data carried by respective subcarriers; and
a processing unit configured to network code the data of at least two of the subcarriers having minimized correlation; and
wherein the processing unit is further configured to map the network coded data to a plurality of resource blocks for relaying to a destination.

28. A relaying method for network coding in a wireless frequency division multiple access network comprising
receiving data carried by respective subcarriers;
linear network coding the data of at least two of the subcarriers; and
mapping the network coded data to a plurality of resource blocks for relaying to a destination.
